(19) United States
(12) Patent Application Publication
(10) Pub. No.: US 2005/0276341 A1
(43) Pub. Date: Dec. 15, 2005

(54) Method and apparatus for transmitting and/or receiving data

(75) Inventor: Thyagarajan Umashankar, Munich (DE)

Correspondence Address: Dicke, Billig & Czaja, PLLC;Suite 2250, Fifth Street Towers Street, 100 South Fifth Street, Minneapolis, MN, 55402, US

(73) Assignee: Infineon Technologies AG

(21) Appl. No.: 10/867,437

(22) Filed: Jun. 14, 2004

(51) Int. Cl. H04K 1/10

(52) U.S. Cl. 375/260

(57) ABSTRACT

A method and an apparatus for transmitting data is described. The data is modulated onto a plurality of carriers. At least one data element of the data is modulated onto at least two different carriers of the plurality of carriers. This technique presents an easy way to transmit data over carriers assigned to noisy channels as through combining the at least two different carriers the signal-to-noise ratio can be increased.

### BACKGROUND

The present invention relates to methods and apparatuses for transmitting and/or receiving data, quadrature amplitude modulated data, over noisy channels. The invention is in particular applicable to data transmission according to discrete multi tone (DMT) modulation widely used in Digital Subscriber Line (xDSL) systems.

xDSL systems are widely used to provide access to the Internet both for enterprises and private customers. Backbone fibers deliver a high-speed digital data stream carrying multiple services to local DSL access multiplexers (DSLAM) which distribute service data to multiple DSL ports, each being equipped with a DSL modem. Each DSL modem usually uses a pair of copper lines to deliver the service to customer premises. To send a corresponding signal over the pair of copper lines, the data is modulated accordingly onto a carrier. In particular, for ADSL (Asymmetric Digital Subscriber Line) and VDSL (Very High Bit Rate Digital Subscriber Line) a multi-carrier modulation technique called discrete multi tone modulation (DMT) is usually used.

This modulation technique is in turn based on quadrature amplitude modulation (QAM), the basic principle of which will be explained with reference to FIGS. 3A and 3B.

In QAM techniques, both the amplitude and the phase of a carrier signal is modulated in order to transmit data. A special case of QAM is termed quadrature phase shift keying (QPSK) where only the phase of the signal is modulated. As amplitude and phase of a signal may also be represented as a complex number, possible constellations of the signal can be easily represented in the complex plane. In FIG. 3A, such a representation for QPSK is shown. The x-axis represents the real part of the complex amplitude, also called in-phase or I-component. The y-axis represents the imaginary part, also called quadrature or Q-component. In the example shown in FIG. 3A, the signal may assume four different constellations marked by four dots 24 which correspond to four different phases of the signal, namely +45°, +135°, +225° and +315°. Since there are four possible constellations, with such a signal two bits may be transmitted, as 2²=4.

In general QAM, not only the phase but also the amplitude is modulated. If, for instance, there are eight possible values (4 positive values and 4 negative values) both for the in-phase and quadrature component, there are sixty-four possible constellations as shown by dots 25 in the diagram of FIG. 3B. This modulation is therefore also called 64-QAM, whereas the modulation shown in FIG. 3A besides QPFK may be also be called 4-QAM. In 64-QAM, six bits may be transmitted simultaneously since 2⁶=64, each possible constellation of the signal corresponding to one of the dots 25 being assigned to one particular bit combination.

The more constellations the signal may assume, the higher the bit rate may be since more bits may be transmitted simultaneously. As can also be taken from FIG. 3A and FIG. 3B, the more constellations there are the closer the constellations are to one another so that requirements for the signal-to-noise ratio (SNR) become higher since for example in FIG. 3B a relatively low noise may lead to a received signal not being assigned to the correct constellation. In FIG. 3A the constellations are more clearly separated from one another and therefore assignment of a signal to the correct constellation and thus a correct demodulation of the signal is more tolerant to noise.

Based on the QAM modulation technique, DMT has been developed. Here, the principle outlined above is applied to a plurality of carriers in parallel. Channels used for these carriers for ADSL transmission are shown in FIG. 4. Here, in a channel 26 normal voice transmission is possible, a frequency 30 at 16 kHz may be used for calculating fees for a service, and in a frequency range between 25,875 kHz to 1104 kHz a plurality of channels 29 is defined, the frequency of each channel being used as a carrier frequency for a carrier for QAM modulation. Some of the channels 29 may be used for data transmission from a central office to the customer premises, as indicated by arrow 28 (“downstream”), and some may be assigned for data transmission in the reverse direction as designated by arrow 27 (“upstream”).

The width of a single channel is, in the present example, 4,3125 kHz. In general, the widths of the channels, the number of channels and the frequency ranges for upstream and downstream direction vary between the various xDSL standards.

In FIG. 5, a schematic block diagram of a transmission system using DMT is shown. A serial data signal a is fed to a serial/parallel converter 31 which converts the serial digital data a into data packets each having a number of sub-packets depending on the number of channels 29 (see FIG. 4) to be used for data transmission. The sub-packets of one data packet are transmitted in parallel to an encoder 32 which encodes each sub-packet, which may comprise one or more bits, onto a separate carrier frequency, one in each channel 20 to be used, according to a QAM modulation as explained with reference to FIGS. 3A and 3B. The so-produced signal vector is fed to an inverse Fourier transformer 3 which performs an inverse Fourier transformation on this vector, resulting in a further digital signal vector comprising samples in the time domain to be sent. This digital signal vector is converted to a series of data elements to be transmitted by a parallel/serial converter 4 and filtered by a digital filter 5. A digital-to-analog converter 6 converts this digital data to analog data which is amplified by a line driver 7 and sent via a transmission channel 8, for example a pair of copper lines. As represented by an adder 9, during transmission noise b is added to the signal. On the receiver side, the signal is equalized and converted from analog to digital by a combined equalizer and analog-to-digital converter 10. Of course, these two functions may also be realized in two separate units. The signal is decoded by performing basically the reverse operations compared to those performed on the transmitter side, namely by a serial/parallel converter 11, a Fourier transformer 12, a decoder 33, a slicer 14 and a parallel serial converter 34. The resulting signal, if no errors occur, corresponds to the signal a.

Such a communication system is for example described in U.S. Pat. No. 6,529,925 B1, the content of which is incorporated by reference herein.

As has already been explained with reference to FIGS. 3A and 3B, the noise b added during transmission may limit the number of constellations and thus the number of bits which may be transmitted simultaneously over a single channel. In general, the signal-to-noise ratio (SNR) is lower for channels or carriers having higher frequencies since these frequencies are attenuated more strongly during transmission, thus reducing the SNR. Therefore, prior to transmission of the actual data, during building up of the communication test data is usually sent to measure the maximum number of constellations possible for each channel. Thereafter, the number of bits assigned to each sub-packet and thus to each channel is chosen dependent on this measurement. Generally, for channels having lower frequencies a higher number of constellations is used (for example as shown in FIG. 3B), whereas for channels with higher frequencies a lower number of constellations is chosen (as shown for example in FIG. 3A). However, if the signal-to-noise ratio becomes too low it may be impossible to transmit even a single bit (corresponding to only two possible constellations) with the desired accuracy, i.e. with a bit error rate below a predetermined threshold.

Techniques have been developed to modulate a so-called fractional bit on a single carrier frequency or tone, for example to use more than one channel to transmit a single bit, so that the number of bits transmitted per channel is actually smaller than one. These known methods generally involve manipulating QAM constellations across several carriers, which, however, is a computationally intensive and complex process using up computational power which may not be available for other processes. Such a process is e.g. described in ITU recommendation 6.992.3, chapter 8.6, the content of which is incorporated by reference herein. On the other hand, just disregarding the channels having a very low signal-to-noise ratio would result in a reduced data rate, in particular for VDSL systems where many channels having high frequencies are used.

For these and other reasons there is a need for the present invention.

### SUMMARY

Embodiments of the present invention provide methods and apparatuses for transmitting and/or receiving data modulated onto one or more carriers which may be used for transmission over noisy channels.

In one embodiment, the present invention provides a method for transmitting data wherein said data is modulated onto a plurality of carriers and at least one data element of said data is modulated onto at least two different carriers of said plurality of carriers. For receiving said data, the modulated data element transmitted at least two times is demodulated by combining the at least two different carriers, for example by averaging the at least two different carriers or by adding the at least two different carriers. Through the use of the at least two different carriers for transmission of the at least one data element the data element can be transmitted over noisy channels where normal transmission would not be possible. Since only modulating the data element onto at least two carriers and averaging is necessary, such a method can be implemented easily.

An alternative embodiment to modulating the at least one data element onto the at least two different carriers is to increase the power of the carrier onto which the at least one data element is modulated.

Another alternative embodiment is to modulate the at least one data element onto a single carrier and to transmit it at least two times, i.e. repeatedly. For demodulation, correspondingly, the at least two transmissions are combined. This alternative is particularly applicable to single-carrier transmission systems.

All these embodiments effectively increase the overall power used for transmitting the at least one data element.

Said data may be modulated onto said plurality of carriers by a phase modulation technique like quadrature amplitude modulation. In particular, the data element may be only one bit in cases where transmission of even a single bit is not possible on a carrier, e.g. due to noise.

Said data may be modulated onto a plurality of carriers in different channels, for example using discrete multi tone modulation. In this case, the method described above may be used for those carriers which correspond to noisy channels, for example channels having a high frequency in VDSL or ADSL systems. Onto the remaining channels, data elements comprising one or more bits are modulated as usual.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a schematic block diagram illustrating a system for data transmission according to one example embodiment of the present invention.

FIGS. 2A-2D are phase diagrams illustrating one embodiment of a method of the present invention. FIGS. 2A, 2B and 2C represent single transmissions and FIG. 2D represents an averaged transmission.

FIGS. 3A and 3B are phase representations illustrating QPSK and 64-QAM, respectively.

FIG. 4 is a schematic representation illustrating channels used for ADSL transmission with discrete multi tone modulation.

FIG. 5 is a block diagram illustrating a system for data transmission according to prior art.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

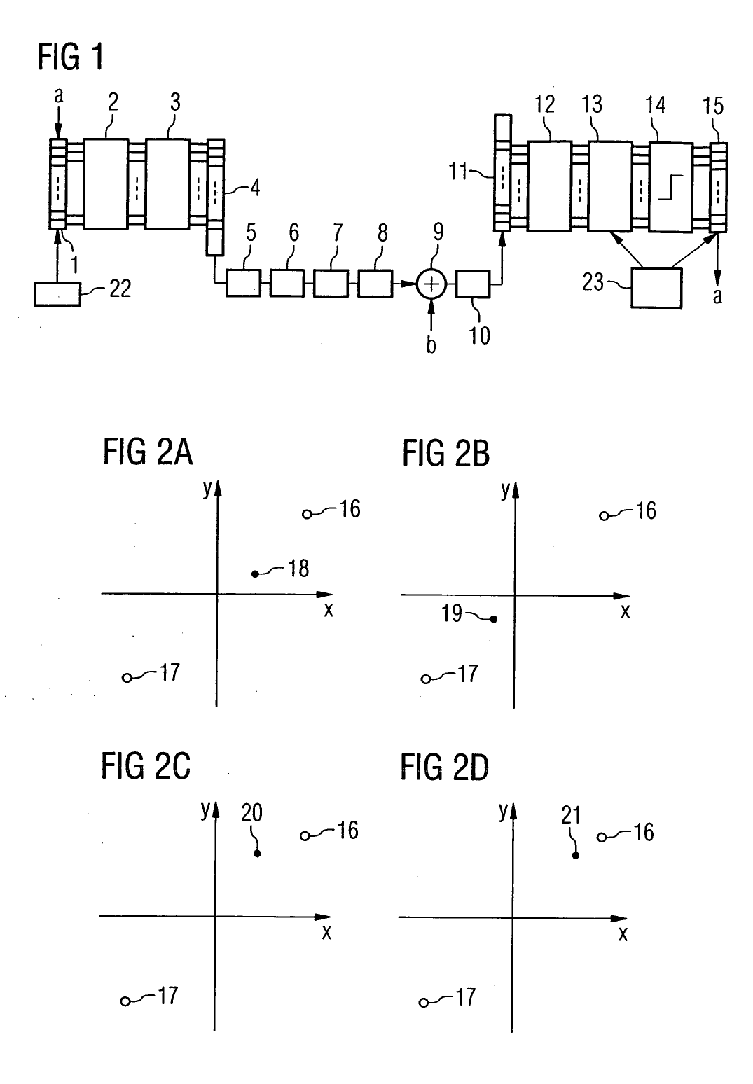

In FIG. 1, a transmission system according to an embodiment of the present invention is illustrated. This transmission system is similar to the transmission system described with reference to FIG. 5, and similar or identical elements bear the same reference numerals. Since these elements were already described in the introductory portion, a detailed description is omitted here and reference is made to the description already given.

The system illustrated in FIG. 1 serves to transmit data modulated according to discrete multi tone modulation (DMT) over a transmission line 8, whereby noise b is added as symbolized by an adder 9. For modulation, as already has been described, a data stream a of data to be sent is divided into packets with a number of sub-packets equal to a number of channels to be used for transmission. Each sub-packet may comprise one or more bits. These sub-packets are sent in parallel to an encoder 2 where the sub-packets are modulated onto respective carriers within the respective channels. For ADSL systems, these channels may have frequencies as described with reference to FIG. 4 in the introductory portion.

For each of the channels, a respective sub-packet is modulated onto a carrier using quadrature amplitude modulation (QAM). The number of constellations possible corresponding to a number of bits being sent simultaneously depends on the signal-to-noise ratio of the respective channel. For some channels, it may not even be possible to send even one bit over the channel with a single sub-packet as noise is too high which would lead to an unacceptable amount of bit errors. These channels are identified during building up the connection. In ADSL systems or VDSL systems this situation may especially occur in high frequency channels, for example in the upper half of the frequency range used.

A synchronization device 22 controls serial/parallel converter 1 so for these channels, the corresponding sub-packets (containing only one bit) are sent to the encoder 2 at least two times in parallel, i.e. for modulation onto two different carriers in two different channels. Alternatively, the first synchronization unit 22 may control the serial/parallel converter 1 to send the respective sub-packet only one time to the encoder 2, and the encoder 2 modulates this sub-packet onto two different carriers. The first synchronization unit 22 is depicted as a separate unit as an example only, its functionality may also be directly included in the serial/parallel converter 1 and/or the encoder 2. In one embodiment, the remaining transmission including the inverse fast Fourier transformation performed by Fourier transformer 3 up to the fast Fourier transmission performed by Fourier transformer 12 works as has already been described with respect to FIG. 5. The channels retrieved through the fast Fourier transformation performed in Fourier transformer 12 are set in parallel to a decoder 13 which is controlled by a second synchronization unit 23 to form the average of the received signals or constellations on those channels where the same encoded sub-packet was sent and to decode this average. To achieve this, decoder 13 comprises a calculating unit for calculating this average. Slicer 14 corresponds to the slicer of the system of FIG. 5. Parallel/serial converter 15 is also controlled by the second synchronization unit 23 to output a signal a which corresponds to the data stream a to be sent input to serial/parallel converter 1. To achieve this, the sub-packets decoded from more than one carrier are only inserted into the data stream once.

As with the first synchronization unit 22, the second synchronization unit 23 is not necessarily a separate unit, but the respective control functionalities may also be directly incorporated in decoder 13 or parallel/serial converter 15 or may be integrated in any suitable control unit present in the respective transmission system.

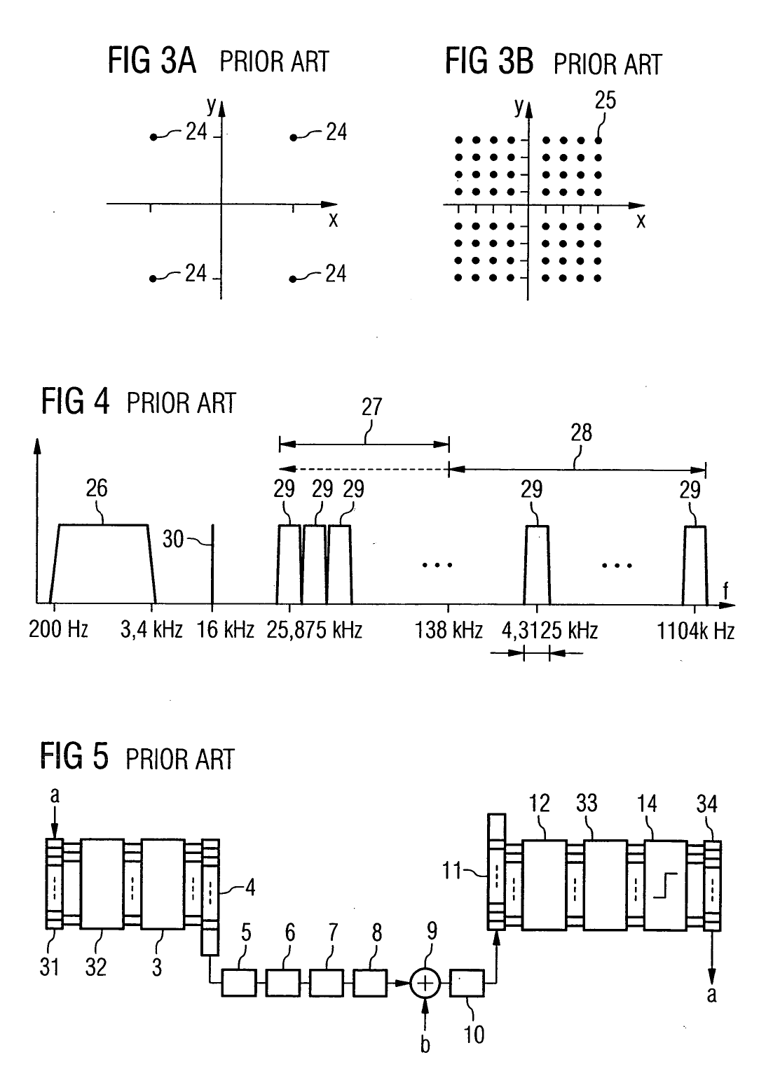

The averaging performed by decoder 13 will now be explained using a simple example with reference to FIGS. 2A-2D. As explained with reference to FIGS. 3A and 3B, constellations, i.e. possible states, of QAM-modulated signals may be represented in a two-dimensional graph which may be viewed as complex numbers or as so-called in-phase (I) and quadrature (Q) components. For representing a single bit, two constellations are necessary to denote the two possible states of the bit. In FIG. 2A, such a representation is given, where on the x-axis the in-phase component of the signal and on the y-axis the quadrature component of the signal is shown. It is assumed that a first possible state of a bit to be sent over a channel corresponds to constellation 16 (for example, a value “1” of the bit), and a second possible value of the bit is represented by constellation 17 (in this case, the value “0”). In the following, it is assumed that a bit having the value “1” corresponding to constellation 16 is to be sent over a noisy channel modulated on a respective frequency. In case of DMT transmission, this may in particular be a channel having a high frequency where the signal-to-noise ratio does not even allow the transmission of a single bit at a time.

Therefore, as has been already explained above, the bit is modulated onto at least two different carriers of at least two different channels. FIG. 2A shows a transmission on a first channel after noise has been added. The received constellation corresponds to dot 18 in FIG. 2A. FIG. 2B shows a respective diagram for the same bit being sent on a second channel. Here, a constellation corresponding to dot 19 is received. Finally, in a transmission on a third channel as shown in FIG. 2C, a constellation corresponding to dot 20 is received. In particular, each constellation taken alone, the transmission on the second channel of FIG. 2B would rather be classified as “0” as “1” since constellation 19 is closer to constellation 17 representing “0” than to constellation 16 representing “1”. Therefore, this constellation alone would mean a bit error has occurred.

According to one embodiment of the invention, as has been explained above, the average of the three received constellations of FIGS. 2A, 2B and 2C is formed, resulting in the constellation 21 shown in FIG. 2D. This constellation can be easily identified as representing a value “1” since it is much closer to constellation 16 than to constellation 17. Of course, instead of forming the average, the three constellations 18, 19 and 20 of FIGS. 2A-2C may simply be added, which, apart from a factor representing the number of constellations, is the same as averaging. Also, depending on the noise actually present on the channel, only two channels/carriers for a single bit or more than three channels/carriers may be used, a higher noise corresponding to a lower signal-to-noise ratio (SNR) requiring a higher number of carriers. Of course, the encoding presented in FIGS. 2A to 2D is to be taken as a simple example for illustrating the principle of the present invention. More complex forms of modulating or mapping bits onto constellations may be used (e.g., Trellis-like encoding).

Also, in principle, it would be possible to modulate more than one bit on the corresponding channels (corresponding to more than two possible constellations) and sending this modulated sub-packet on more than one channel in order to get a better signal-to-noise ratio. However, in this case, it will be usually easier to reduce the number of possible constellations instead of sending the respective encoded data on more than one channel.

In principle, instead of sending the encoded sub-packet on more than one channel, it would also be possible to increase the transmit power on the respective channel. While this is also envisioned as a possibility, it may require greater effort in designing respective line amplifiers and signal processing elements as those would have to be adapted to be able to cope with the higher transmit power. Therefore, sending on more than one channel is generally easier to implement. It should be noted that in fact sending the respective encoded sub-packet on more than one channel effectively also corresponds to an increase of the power used for each encoded sub-packet or data element, which may be seen as a sum of the power of all the single transmissions in the respective channels.

A further alternative embodiment would be transmitting the same data element on the same carrier repeatedly and then performing the averaging or addition. However, in this case respective sorting algorithms and intermediate storage means would be necessary in decoder 13 and/or parallel/serial converter 15 in order to keep the correct order of the transmitted bits in case of multi-carrier transmission methods like DMT. However, for single carrier techniques like QAM this alternative is well applicable.

In the above embodiment, the invention has been described with reference to a transmission system using discrete modulation techniques. However, in principle, the invention is applicable to all cases where data is to be transmitted over noisy channels and where the modulated signal to be sent may assume at least two states, like the two constellations 16 and 17 shown in FIG. 2A. In particular, the invention is also usable for systems using a single channel instead of the plurality of channels used in DMT system, for example for system using QAM.

Furthermore, instead of averaging the received constellations as explained with reference to FIGS. 2A-2D, it would also be possible to demodulate the constellations separately and determine the value of the transmitted sub-packet by a majority vote between the results. For the constellations of FIGS. 2A-2C, this would mean received values of “1”, “0” and “1”, respectively, leading to an overall result of “1” since “1” has been received more often than “0”. However, averaging before demodulation usually yields better results.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method for transmitting data comprising:
modulating the data onto a plurality of carriers; and
modulating at least one data element of the data onto at least two different carriers of the plurality of carriers.

2. The method according to claim 1, comprising:
demodulating the at least one data element by combining the at least two different carriers and demodulating the combined at least two carriers.

3. The method according to claim 2, comprising:
combining the at least two different carriers by averaging the at least two different carriers.

4. The method according to claim 2, comprising:
combining the at least two carriers are combined by adding the at least two carriers.

5. The method according to claim 1, comprising:
combining the at least one data element from the at least two different carriers by demodulating the at least two different carriers and combining the at least two demodulated carriers.

6. The method according to claim 1, comprising:
modulating the data onto the at least two different carriers with a phase modulation technique.

7. The method according to claim 6, comprising:
defining the the phase modulation technique as quadrature amplitude modulation.

8. The method according to claim 6, comprising:
defining the phase modulation technique as discrete multi tone modulation.

9. The method according to claim 1, comprising defining the at least two carriers of the plurality of carriers as carriers of channels having a lower signal-to-noise ratio than channels corresponding to other carriers of the plurality of carriers.

10. The method according to claim 1, comprising:
defining the at least two carriers of the plurality of carriers to have frequencies higher than frequencies of at least half of the plurality of carriers.

11. The method of claim 1, comprising:
defining the number of the at least two carriers to be two.

12. The method according to claim 1, comprising:
defining the at least one data element to be one bit.

13. A method for transmitting data, comprising:
modulating the data onto a plurality of carriers using a phase modulation technique;
modulating each data element of a first group of data elements of said data onto respective single carriers of the plurality of carriers; and
modulating each data element of a second group of data elements of the data onto at least two respective carriers of the plurality of carriers.

14. The method according to claim 13, comprising:
modulating the data onto the plurality of carriers using discrete multi tone modulation.

15. The method according to claim 13, comprising:
defining the data elements of the second group of data elements as single bits.

16. A method for transmitting data, comprising:
modulating the data onto at least one carrier; and
transmitting at least one data element of the data modulated onto the at least one carrier at least two times.

17. The method according to claim 16, comprising:
recovering the data element transmitted at least two times by combining the at least two transmissions of the data element.

18. A method for transmitting data, comprising:
modulating the data onto a plurality of carriers, and
adjusting a transmit power of at least one of the plurality of carriers depending on a signal-to-noise ratio of a transmit channel comprising the at least one carrier.

19. A method for receiving data, comprising:
modulating the data onto a plurality of carriers;
receiving at least one data element of the data on at least two different carriers; and
recovering the at least one data element by demodulating a combination of the at least two carriers.

20. The method according to claim 19, comprising:
modulating the data onto the plurality of carriers using a phase modulation technique.

21. An apparatus for transmitting data, comprising:
an encoder for modulating the data onto a plurality of carriers,
wherein the encoder is configured to modulate at least one data element of the data onto at least two different carriers of the plurality of carriers.

22. The apparatus according to claim 21, comprising:
wherein the encoder is configured to modulate the data onto the plurality of carriers using a phase modulation technique.

23. The apparatus according to claim 22, comprising:
wherein the phase modulation technique is quadrature amplitude modulation.

24. The apparatus according to claim 22, comprising:
wherein the phase modulation technique is discrete multi tone modulation.

25. The apparatus according to claim 21, comprising:
wherein the at least two carriers of the plurality of carriers are carriers of channels having a lower signal-to-noise ratio than channels corresponding to other carriers of the plurality of carriers.

26. The apparatus according to claim 21, comprising:
wherein the at least two carriers of the plurality of carriers have frequencies higher than frequencies of at least half of the plurality of carriers.

27. The apparatus of claim 21, comprising:
wherein the number of the at least two carriers is two.

28. The apparatus according to claim 21, comprising:
wherein the at least one data element is one bit.

29. An apparatus for transmitting data, comprising:
an encoder configured for modulating the data onto a plurality of carriers using a phase modulation technique, wherein the encoder is configured such that each data element of a first group of data elements of the data is modulated on respective single carriers of the plurality of carriers, and each data element of a second group of data elements of the data is modulated onto at least two respective carriers of the plurality of carriers.

30. The apparatus according to claim 29, comprising:
wherein the encoder is configured such that the data is modulated onto the plurality of carriers using discrete multi tone modulation.

31. The apparatus according to claim 29, comprising:
wherein the data elements of the second group of data elements are single bits.

32. An apparatus for transmitting data, comprising:
encoding means for modulating the data onto at least one carrier; and
transmitting means configured such that at least one data element of the data modulated onto the at least one carrier is transmitted at least two times.

33. An apparatus for transmitting data, comprising:
encoding means for modulating the data onto a plurality of carriers; and
means for adjusting a transmit power of at least one of the plurality of carriers depending on a signal-to-noise ratio of a transmit channel using the at least one carrier.

34. The apparatus of claim 33, comprising:
decoding means which configured such that the at least one data element is recovered by demodulating a combination of the at least two carriers.
